(19) United States
(12) Patent Application Publication
(10) Pub. No.: US 2024/0153673 A1
(43) Pub. Date: May 9, 2024

(54) FLAT FLAME-RETARDANT HARNESS SYSTEM AND BATTERY MODULE HAVING SAME

(71) Applicant: LATTRON.CO., LTD., Daejeon (KR)

(72) Inventors: Young Sung Wang, Daejeon (KR); Jeonghoon Je, Daejeon (KR); Gyusang Choi, Daejeon (KR)

(21) Appl. No.: 18/549,753

(22) PCT Filed: Mar. 10, 2022
(86) PCT No.: PCT/KR2022/003399

§ 371 Date: Sep. 8, 2023

(30) Foreign Application Priority Data
Mar. 10, 2021 (KR) 10-2021-0031241

(51) Int. Cl. H01B 7/295; H01M 10/42; H01M 50/383; H01M 50/507

(52) U.S. Cl. CPC H01B 7/295; H01M 10/425; H01M 50/383; H01M 50/507; H01M 2010/4271

(57) ABSTRACT

A flat flame-retardant harness system includes: a conductor including a plurality of connection contacts, a first position provided with a connector and a second position provided with a temperature sensor, and a wiring pattern for electrically connecting the plurality of connection contacts and the second position to the first position; a lower non-combustible layer provided to contact a lower portion of the conductor, having a plurality of first bus bar coupling portions having first holes formed at positions corresponding to the plurality of connection contacts, and including a flame-retardant material; and an upper non-combustible layer provided to contact the upper portion of the conductor, having a plurality of second bus bar coupling portions having second holes formed at positions corresponding to the plurality of connection contacts, and including a flame-retardant material, wherein each connection contact contacts a bus bar by a first means, and thus is electrically connected.

### CROSS-REFERENCE TO RELATED APPLICATIONS

This application is a National Phase entry pursuant to 35 U.S.C. 371 of International Application No. PCT/KR2022/003399 filed on Mar. 10, 2022, which claims priority to and the benefit of Korean Patent Application No. 10-2021-0031241 filed on Mar. 10, 2021, the disclosures of which are incorporated herein by reference in their entirety.

### TECHNICAL FIELD

The present disclosure relates to a flat flame-retardant system harness and a battery module including the flat flame-retardant system harness.

### BACKGROUND

In general, an energy storage system (ESS) or an electric vehicle is equipped with a battery management system (BMS) to prevent battery negligent accidents and efficiently manage electric energy of the battery. In order to provide the battery management system with corresponding information (voltage, current, etc.), a bus bar connecting electrode leads of each battery cell is connected to a printed circuit board (PCB) with a wire harness, and the PCB is electrically connected to the battery management system. That is, information on each battery cell provided through the bus bar is collected on the PCB through the wire harness, and the PCB provides the collected information to the battery management system.

Meanwhile, the battery module may cause a fire due to an external shock or internal/external overheating resulting in a short circuit and thermal runaway of the battery.

However, for such an initial fire, since the conventional wire harness is vulnerable to fire, a short is induced, causing additional explosion or fire spread.

So, in the prior art, various methods have been proposed to solve the problem caused by the battery fire.

The proposed method may include installing a fuse in an energy storage device to cut off an electrical short circuit in the energy storage device in case of overheating and overcurrent, adding a short-down separator made of a polymer material that dissolves easily at an appropriate high temperature and a material with a fire extinguishing function is added inside the energy storage device to prevent fire by melting the separator to spread the fire extinguishing agent in case of overheating, and installing a small compressed air tank and a fire extinguisher tank that may serve a similar role as an existing fire extinguisher in a battery cover to automatically extinguish fire in the event of a fire or impact to prevent further fires.

However, the conventional methods have disadvantages in terms of cost increase due to the addition of manufacturing processes and maintenance of compressed air tanks.

The following references include subject matter that is related to subject matter disclosed herein:
1. Korean Patent No. 10-2123684 (Registration date: Jun. 10, 2020) (Title: ESS battery device with fire extinguishing function)
2. Korean Patent No. 10-2010012 (Registration date: Aug. 6, 2019) (Title: Battery
pack with fire extinguishing device and control method using the same) 3. Korean Patent Publication No. 10-2009-0326648 (Published on Mar. 13, 2009) (Title: Battery pack).

### SUMMARY

The present disclosure relates to a battery module. Particular embodiments relate to a flat flame-retardant system harness capable of preventing the spread of a fire occurring in a battery and a battery module including the flat flame-retardant system harness.

Aspects of the present disclosure are directed to a flat flame-retardant system harness having a structure that does not use a wire harness and a battery module including the same.

Aspects of the present disclosure are also directed to a flat flame-retardant system harness preventing the spread of battery fire and a battery module including the same.

The present disclosure is not limited to the above aspects, and other aspects may be inferred from the following embodiments.

According to an embodiment of the present disclosure, a flat flame-retardant system harness provided on a plurality of bus bars formed in a battery cell assembly includes: a conductor including a plurality of connection contacts formed to be electrically connect to the plurality of bus bars, a first position formed to be connected to a battery management system (BMS), and a wiring pattern formed to electrically connect the plurality of connection contacts to the first position; a lower non-combustible layer provided in contact with a lower portion of the conductor and including a plurality of first bus bar coupling portions having first holes at positions corresponding to the plurality of connection contacts, and an upper non-combustible layer provided in contact with an upper portion of the conductor and including a plurality of second bus bar coupling portions having second holes at positions corresponding to the plurality of connection contacts, wherein each connection contact is electrically connected to the bus bar by a first means, and at least one of the lower non-combustible layer and the upper non-combustible layer includes a flame-retardant material.

The first means may pass through a third hole formed at the connection contact, the first hole, the second hole, and the bus bar such that the connection contact and the bus bar closely contact each other.

The first means may be a device for welding the connection contact and the bus bar, or a device or connection member for fusing the connection contact and the bus bar.

The lower non-combustible layer may include: a bottom layer including a silicone sheet; a top layer including a silicone sheet; and a middle layer including a non-combustible fiber material and disposed between the bottom layer and the top layer.

The upper non-combustible layer may include: a bottom layer including a silicone sheet; a top layer including a silicone sheet; and a middle layer including a non-combustible fiber material and disposed between the bottom layer and the top layer.

The conductor may be made of a single conductive material.

The first bus bar coupling portion and the second bus bar coupling portion may have a cutout cut in a ‘c’ shape around the first hole or the second hole.

The conductor may further include a cutout cut in a ‘c’ shape around the third hole formed in the connection contact.

According to another embodiment of the present disclosure, a battery module includes the flat flame-retardant system harness.

According to an embodiment of the present disclosure, the use of a wire harness is eliminated so that when a fire occurs in a battery module, a short between batteries due to wire harness combustion is prevented, and additional fire is blocked and prevented through flame retardation.

### BRIEF DESCRIPTION OF THE DRAWINGS

FIG. 1 is an exploded perspective view illustrating a battery module including a flat flame-retardant system harness according to a first embodiment of the present disclosure.

FIG. 2 is an exploded perspective view illustrating a battery module including a flat flame-retardant system harness according to a second embodiment of the present disclosure.

FIG. 3 is an exploded perspective view illustrating a battery module including a flat flame-retardant system harness according to a third embodiment of the present disclosure.

FIG. 4, which includes FIGS. 4A and 4B, is a view illustrating a bus bar assembly used in a battery module including a flat flame-retardant system harness according to an embodiment of the present disclosure.

FIG. 5, which includes FIGS. 5A and 5B, is a view illustrating a configuration of lower and upper non-combustible layers in a system harness according to an embodiment of the present disclosure.

FIG. 6 is a view illustrating a process of manufacturing a system harness according to an embodiment of the present disclosure.

FIG. 7, which includes FIGS. 7A, 7B, 7C, and 7D, is a view illustrating an upper non-combustible layer of a system harness according to an embodiment of the present disclosure.

FIG. 8, which includes FIGS. 8A and 8B, is a view illustrating a conductor in a flat flame-retardant system harness according to an embodiment of the present disclosure.

### DETAILED DESCRIPTION OF ILLUSTRATIVE EMBODIMENTS

Hereinafter, several embodiments will be described clearly and in detail with reference to the accompanying drawings so that a person having ordinary skill in the art (hereinafter, those skilled in the art) may easily practice the present disclosure. Also, the term “portion (unit)” used in the specification may mean a hardware component or circuit.

Hereinafter, a flat flame-retardant system harness and a battery module including the flat flame-retardant system harness according to an embodiment of the present disclosure will be described with reference to the accompanying drawings.

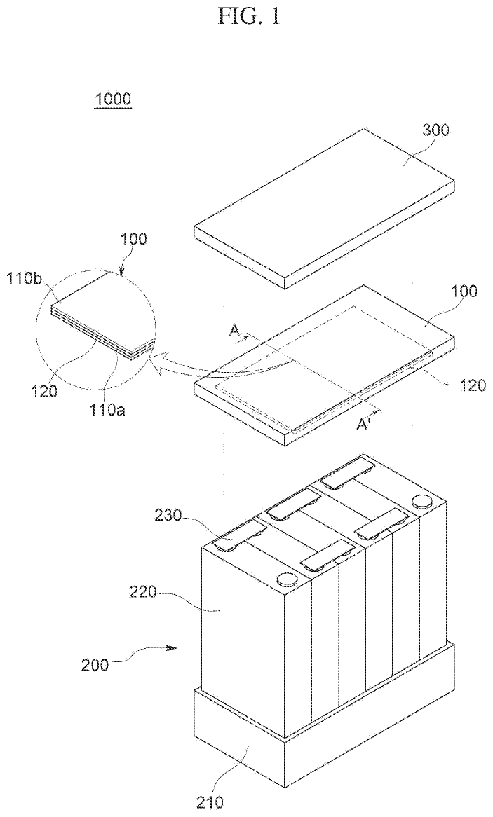

FIG. 1 is an exploded perspective view illustrating a battery module including a flat flame-retardant system harness according to a first embodiment of the present disclosure. Referring to FIG. 1, a flat flame-retardant system harness wo and a battery module woo including the same according to a first embodiment of the present disclosure include a battery system harness 100, a battery cell assembly 200, and an upper cover 300.

The battery cell assembly 200, which is an assembly in which a plurality of battery cells 220 are stacked, includes the plurality of battery cells 220, a stacking plate 210 on which the plurality of battery cells 220 are stacked, and a plurality of bus bars 230 connecting the plurality of battery cells 220 in series or parallel by electrically connecting electrode leads of the battery cells 220 alternately to each other with cathodes connected to anodes.

In such a case, although the battery cell 220 is illustrated as being a quadrangular battery cell, it may be a circular battery cell.

In addition, although the stack plate 210 is illustrated as having a form in which a portion of the stacked battery cells 220 is exposed, the stacked plurality of battery cells 220 may be entirely inserted and stacked without being exposed. In addition, when the stack plate 210 is configured in a form in which a portion of the stacked plurality of battery cells 220 is exposed, a separate configuration that is coupled to the stack plate 210 to cover the entirety of the plurality of battery cells 220 may be provided or it may be configured such that the upper cover 300 is coupled with the stack plate 210 to cover the plurality of battery cells 220. Since various forms of the battery cell assembly 200 belong to known technology, a detailed description thereof will be omitted.

The flat flame-retardant system harness 100 (hereinafter, ‘system harness 100’) has a flat plate shape, and an outer surface may be entirely flame-retardant. The system harness 100 is provided on or above a portion where the plurality of bus bars 230 are formed in the battery cell assembly 200 to prevent the fire from spreading in case of a battery fire. In order to prevent the spread of fire, the system harness 100 is composed of a flame-retardant lower non-combustible (e.g., nonflammable) layer 110a and a flame-retardant upper non-combustible layer 110b, and a conductor 120 is sealed and positioned between the flame-retardant lower non-combustible layer 110a and the flame-retardant upper non-combustible layer 110b.

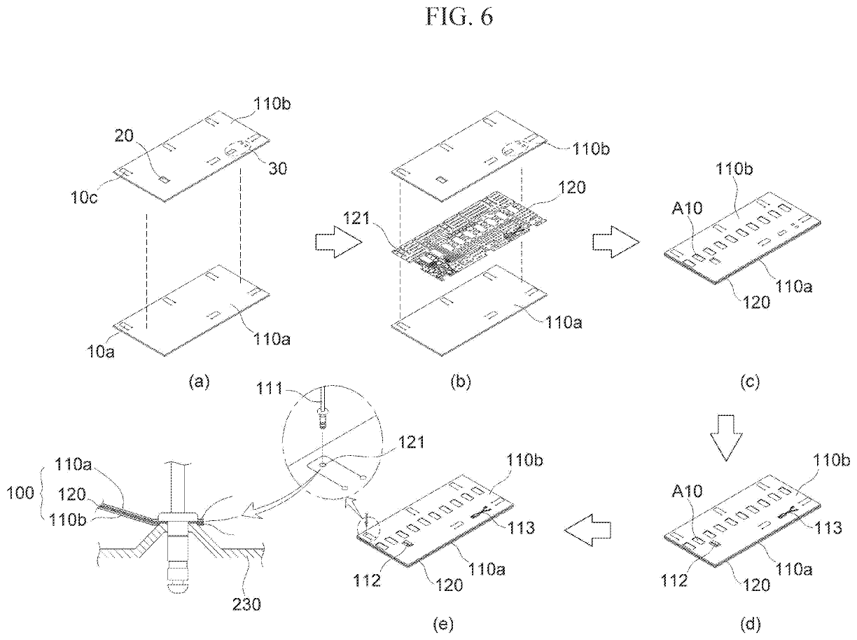

The conductor 120 may include a conductive material such as iron, copper, aluminum, gold, or silver that conducts electricity, and have a first position to be electrically connected to the battery management system, and a plurality of connection contacts (see 121 in FIG. 6) to be electrically connected to the plurality of bus bars 230, and a wire for electrically connecting the plurality of connection contacts to the first position is formed.

The connection contact 121 refers to a certain portion electrically contacting the bus bar 230.

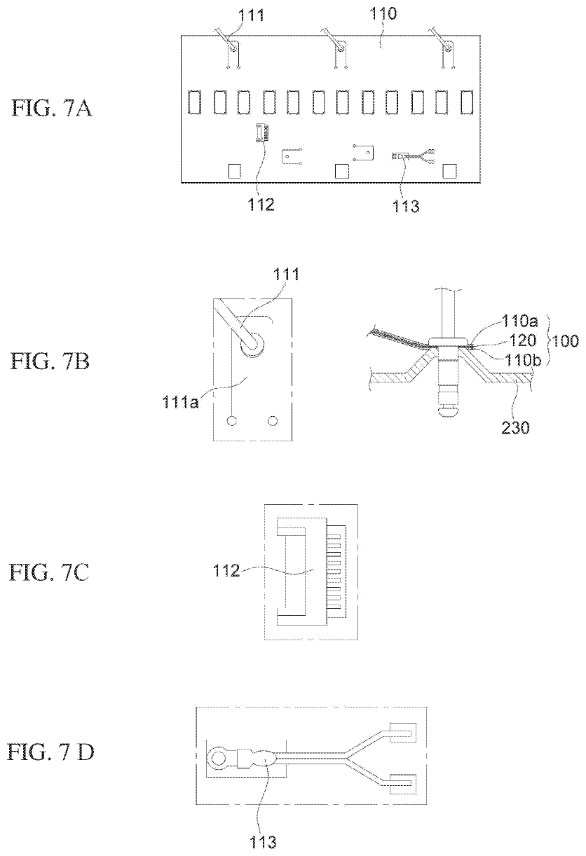

The connection contact 121 may have a hole to be connected to the bus bar 230, and a connection means electrically connected to the battery management system is installed at the first position. The connecting means may be a connector (see 112 in FIG. 7) or other electrical connection members or devices such as FPCB.

In addition, the conductor 120 may have a second position where a temperature sensor (see 113 in FIG. 7) is installed. In such a case, the second position is electrically connected to the first position through a wire.

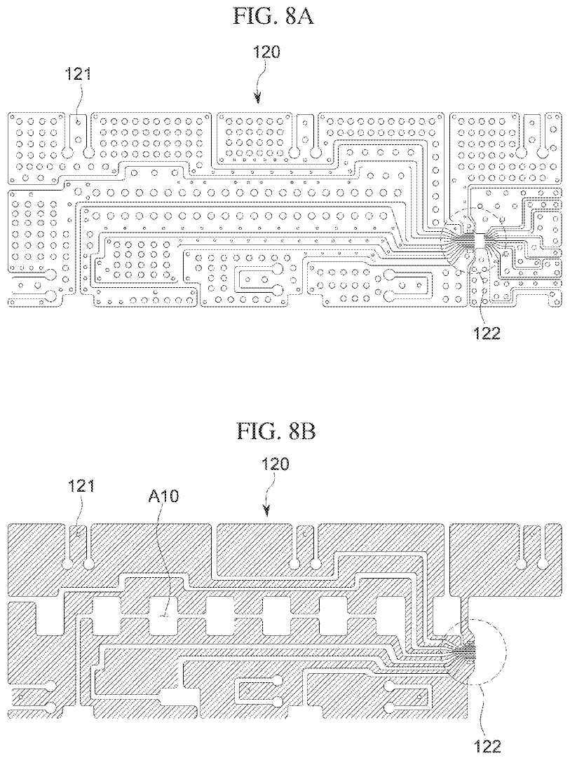

Accordingly, the conductor 120 may have a simplest configuration as illustrated in FIG. 8 and may be manufactured with only one conductive material having a wiring pattern. It is obvious that the conductor 120 may be made into a general rigid PCB or flexible PCB.

The system harness 100 is configured not to use a wire harness when electrically connected to the bus bar. For example, conventionally, a terminal of a wire harness was connected to the connection contact of the conductor 120, but the system harness 100 according to an embodiment of the present disclosure electrically connects the connection contact 121 of the conductor 120 and the bus bar 230 by welding or fusion, or connects them by using a connection member to pass through the connection contact 121 and the bus bar 230 and couple (e.g., fasten) them.

In addition, the system harness 100 serves to sense a voltage of the battery cell 220 or the battery module moo or sense a temperature of the battery module moo.

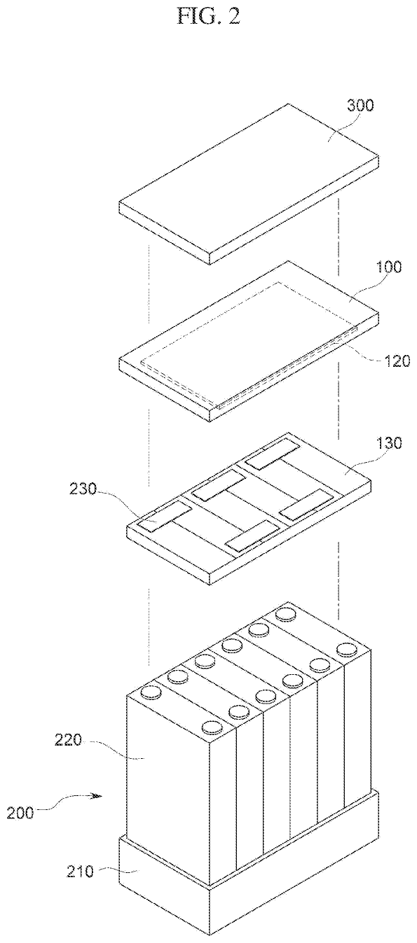

FIG. 2 is an exploded perspective view illustrating a battery module including a flat flame-retardant system harness according to a second embodiment of the present disclosure. Referring to FIG. 2, a battery module 1000 including a flat flame-retardant system harness according to a second embodiment of the present disclosure includes a system harness 100, a battery cell assembly 200, an upper cover 300, and a bus bar assembly 130.

In a configuration according to the second embodiment of the present disclosure, a plurality of bus bars 20 installed in the battery cell assembly 200 are separated from the configuration according to the first embodiment of the present disclosure, and are formed in the form of the bus bar assembly 130.

Accordingly, the battery cell assembly 200 includes a plurality of battery cells 220, a stacking plate 210 on which the plurality of battery cells 220 are stacked, and the bus bar assembly 130.

The bus bar assembly 130 includes a plurality of bus bars 230 installed thereon, and each bus bar 230 is connected to an electrode lead of each battery cell 220 formed on an upper side of the battery cell assembly 200 to connect the plurality of battery cells 220 in series. Each bus bar 230 of the bus bar assembly 130 is electrically connected to the conductor 120 of the system harness 100.

The bus bar assembly 130 configured as described above is installed on the battery cell assembly 200, and the system harness 100 is installed on an upper surface of the bus bar assembly 130.

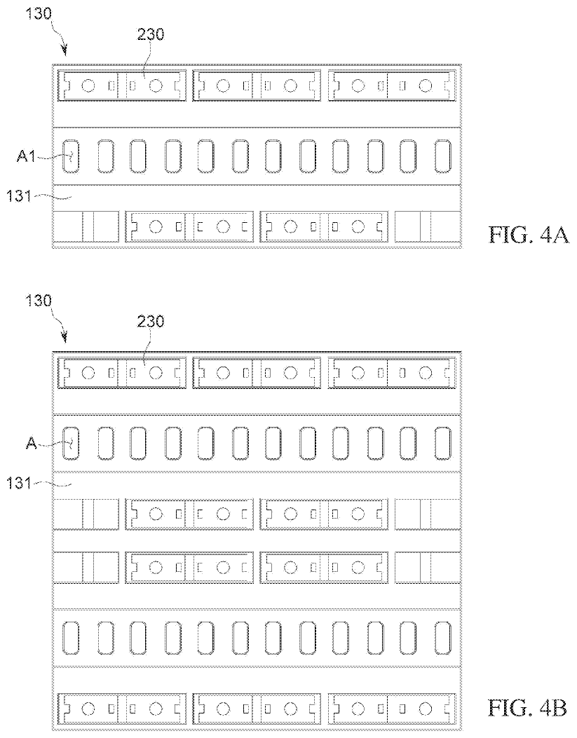

Hereinafter, the bus bar assembly 130 applied to the battery module 1000 according to the second embodiment of the present disclosure will be described in detail with reference to FIG. 4.

FIG. 4 is a view illustrating an example of a bus bar assembly used in a battery module including a flat flame-retardant system harness according to an embodiment of the present disclosure. FIG. 4A illustrates a bus bar assembly 130 applicable to the battery module woo according to the second embodiment of the present disclosure), and FIG. 4B illustrates a bus bar assembly 130 applicable to a battery module 1000 according to a third embodiment of the present disclosure to be described below.

Referring to FIG. 4A, the bus bar assembly 130 includes a quadrangular plate 131 having a plurality of protruding holes A and a plurality of bus bars 230 installed on the plate 131. Positions of the plurality of bus bars 230 formed on the plate 131 vary according to an arrangement of the connected battery cells. In FIG. 4A, it is illustrated that five bus bars 230 are installed corresponding to six battery cells. In FIG. 4B, a bus bar assembly in which two bus bar assemblies 130 illustrated in FIG. 4A are integrated (or connected) is illustrated.

The plurality of protruding holes A are for coupling with the system harness 100 and consist of at least one or more. The plurality of protruding holes A may be omitted if coupling to the system harness 100 is configured in other methods.

Meanwhile, a support member (not illustrated) may be installed to support an upper cover 300 when the upper cover 300 is installed. The support member is a member to support the upper cover 300 so that it does not come down any further when the battery module 1000 is sealed. When the support member is installed, it is preferable that a through hole (not illustrated) through which the support member passes is installed in the system harness 100.

Accordingly, the system harness 100 according to an embodiment of the present disclosure is manufactured corresponding to the bus bar, the protruding hole A, and the support member installed in the bus bar assembly 130.

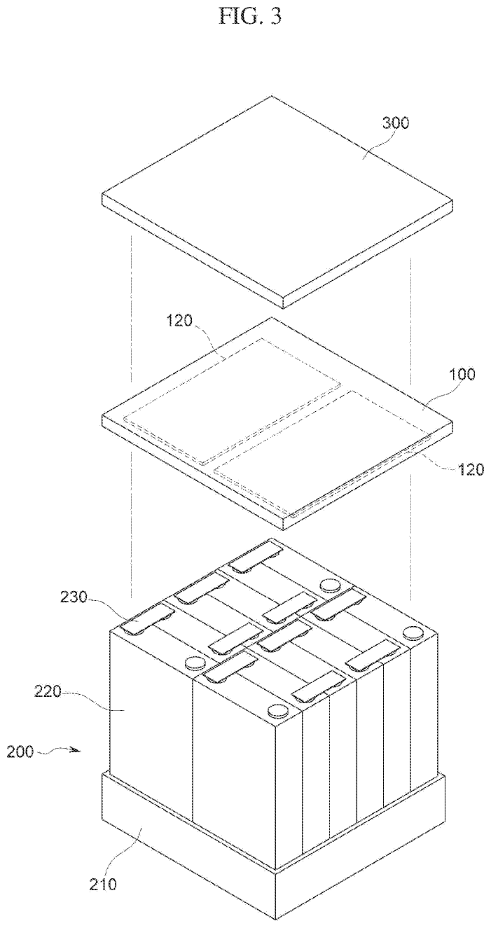

FIG. 3 is an exploded perspective view illustrating a battery module including a flat flame-retardant system harness according to a third embodiment of the present disclosure. Referring to FIG. 3, the battery module 1000 including a flat flame-retardant system harness according to the third embodiment of the present disclosure is for the case of adding one or more battery cell assemblies 200 illustrated in FIGS. 1 and 2 to expand in a horizontal or vertical direction.

FIG. 3 illustrates a case in which one battery cell assembly 200 is expanded in the horizontal direction, and in such a case, the battery module 1000 including a flat flame-retardant system harness according to the third embodiment of the present disclosure includes a system harness 100, two battery cell assemblies 200 and an upper cover 300.

In such a case, the system harness 100 is configured to include two conductors 120 corresponding to the two battery cell assemblies 200.

It is obvious that the system harness 100 may use a conductor in which two conductors 120 are integrated into one corresponding to the two battery cell assemblies 200. However, in the case of using one conductor corresponding to the addition of the battery cell assembly 200, it will be a burden to manufacture a conductor separately.

On the other hand, as another embodiment, the present disclosure may be configured to correspond to the case where the battery cell assembly 200 is expanded as illustrated in FIG. 3 by modifying the battery module moo according to the second embodiment of the present disclosure illustrated in FIG. 2. In such a case, the bus bar assembly illustrated in FIG. 4(b) or a modification thereof will be used.

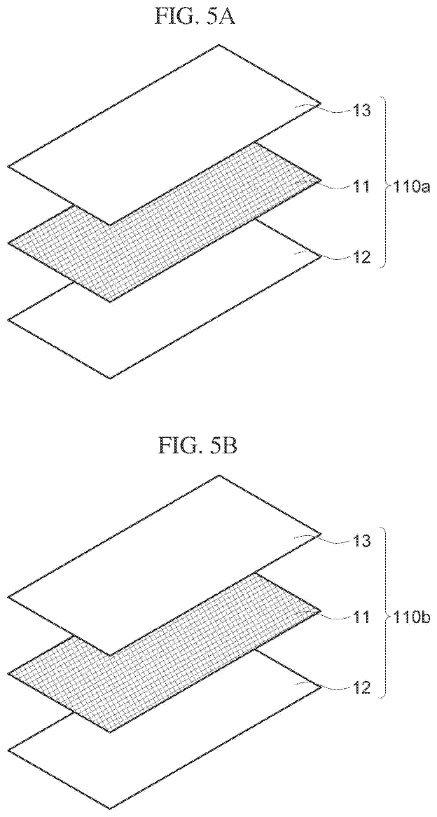

Hereinafter, a system harness according to an embodiment of the present disclosure will be described with reference to FIGS. 5 to 7.

FIG. 5 is a view illustrating a configuration of lower and upper non-combustible layers in a system harness according to an embodiment of the present disclosure, FIG. 5A illustrates a lower non-combustible layer 110a, and FIG. 5B illustrates an upper non-combustible layer nob.

Referring to FIGS. 5A and 5B, the lower non-combustible layer 110a and the upper non-combustible layer nob according to an embodiment of the present disclosure are manufactured with the same configuration. Accordingly, only the lower non-combustible layer 110a will be described below.

The lower non-combustible layer 110a according to an embodiment of the present disclosure may include three layers, that is, a bottom layer 12, a middle layer 11, and a top layer 13.

The middle layer 11 includes a fiber material made of a non-combustible material such as glass fiber or carbon fiber. The fiber materials are woven with non-combustible fiber materials so that flames do not pass and do not burn even at high temperatures. However, since the fiber material is made by weaving, it has a disadvantage that it is easy to unravel.

In order to overcome this disadvantage, the middle layer 11 is disposed between the bottom layer 12 and the top layer 13. Specifically, both the bottom layer 12 and the top layer 13 are silicone sheets with excellent flame retardancy, and are coupled (bonded) to the middle layer 11 to prevent the fiber material of the middle layer 11 from unraveling.

FIG. 6 is a view illustrating a process of manufacturing a system harness according to an embodiment of the present disclosure, and relates to the case of coupling with the bus bar assembly 130. Referring to FIG. 6, first, as illustrated in step (a), in order to secure a space for installing or connecting components in the conductor 120, a bus bar coupling portion boa is processed on the lower non-combustible layer 110a and the upper non-combustible layer nob.

Specifically, with respect to the lower non-combustible layer 110a, the bus bar coupling portion boa having a hole penetrating the bus bar 230 and a connection contact 121 of the conductor to connect the bus bar 230 and the conductor is formed. It is preferable that the hole of the bus bar coupling portion boa is formed in a size that allows the connection contact to be exposed to the outside when bonded to the conductor 120.

The bus bar coupling portion boa may further have a cutout cut in a ‘c’ shape (including extending to appear as a ‘u’ shape) around the hole to facilitate connection between the bus bar 230 and the connection contact 121 of the conductor. In such a case, the ‘c’-shaped cutout facilitates moving the hole toward the bus bar 230. The bus bar coupling portion boa is formed corresponding to the position of the bus bar 230 installed in the battery cell assembly 200.

Similar to the lower non-combustible layer 110a, the upper non-combustible layer 110b has a bus bar coupling portion 10c having a hole penetrating the bus bar 230 and the connection contact 121 of the conductor to connect the bus bar 230 and the conductor is formed. It is preferable that the hole of the bus bar coupling portion 10c has a size such that the connection contact is not exposed to the outside when the conductor 120 and the bus bar 230 are electrically connected to each other with a connecting member 111 such as a rivet, and has a size such that the connection contact is exposed to the outside when the conductor 120 and the bus bar 230 are electrically connected to each other through welding or fusion. It is obvious that the hole size of the bus bar coupling portions 10a and 10c is not limited to the above description and may be arbitrarily changed by the manufacturer during manufacture.

The bus bar coupling portion 10c may further have a cutout cut in a ‘c’ shape around the hole to facilitate connection of the bus bar 230 with the connection contact 121 of the conductor. The bus bar coupling portion 10c is formed corresponding to the position of the bus bar 230 installed in the battery cell assembly 200. Then, a connector recess 20 is processed corresponding to a connector installation position of the conductor 120 in the upper non-combustible layer nob, and a sensor recess 30 is processed corresponding to an installation position of a temperature sensor 130 of the conductor 120.

As illustrated in step (b) of FIG. 6, the lower non-combustible layer 110a having the bus bar coupling portion boa formed thereon and the upper non-combustible layer nob having the bus bar coupling portion 10c, the connector recess 20 and the sensor recess 30 formed thereon are attached to front and rear surfaces of the conductor 120, respectively, according to a wiring pattern of the conductor 120 to make a semi-finished product. Accordingly, the hole of the connection contact 121 of the conductor 120 coincides with the hole of the bus bar coupling portions boa and bob. In such a case, in the conductor 120, a cutout in a ‘c’ shape corresponding to the bus bar coupling portions 10a and 10c may be formed around the hole of the connection contact 121 (see FIG. 8).

Then, as illustrated in step (c) of FIG. 6, a plurality of coupling holes A10 for coupling with an upper portion where the bus bar 230 of the battery cell assembly 200 is installed, or the bus bar assembly 130 are formed in the semi-finished state. For example, when coupling with the bus bar assembly 130, the coupling hole A10 is coupled with the protruding hole A of the bus bar assembly 130.

When the coupling hole A10 is formed, as illustrated in step (d) of FIG. 6, a connector 112 is installed on the conductor 120 through the connector recess 20, and a temperature sensor 113 is installed on the conductor 120 through the sensor recess 30.

Finally, as illustrated in step(e) of FIG. 6, the connection member 111 passes through the hole of each bus bar coupling portion 10a, 10c and the hole of the connection contact 121 to be coupled with the bus bar 230. Accordingly, the connection member in electrically connects the connection contact 121 exposed through the hole of each bus bar coupling portion 10a, 10c and the bus bar 230.

Herein, the connection member 111 may be any material capable of compressing and adhering two objects, such as rivets or washers.

Meanwhile, as another embodiment of the present disclosure, as a method of electrically connecting the bus bar 230 and the connection contact 121 of the conductor 120, there is a method of welding the bus bar 230 and the connection contact 121 of the conductor 120. For example, there are various methods such as welding using a laser, welding using an ultrasonic wave, or welding using a solder ball. In the connection method by welding, the connection contact 121 does not have a hole.

Also, as another embodiment of the present disclosure, there is a method of electrically connecting the bus bar 230 and the connection contact 121 of the conductor 120 through fusion using a fusion device (including a fusion member). As the fusion method, a conventional fusion method such as ultrasonic fusion is applied.

In the present disclosure, flame-retardant treatment may be performed by applying a highly heat-resistant silicone to the connection member in, the connector 112, and the temperature sensor 113 exposed to the outside.

In addition, according to the present disclosure, the system harness 100 in which the connector 112 and the temperature sensor 113 are not installed may be manufactured by omitting the process of step (d).

FIG. 7 is a view illustrating an upper non-combustible layer of a system harness according to an embodiment of the present disclosure. Referring to FIG. 7, the rivet in installed in each bus bar coupling portion Doc has an exposed portion, and the connector 112 and the temperature sensor 113 are installed to be exposed. FIG. 7A is a view illustrating the conductor 120 in the form of a finished product in which each part is installed, viewed from above. In addition, FIGS. 7B, 7C, and 7D illustrate each of components 111, 112, and 113 exposed to the upper non-combustible layer nob.

FIG. 8 is a view illustrating a conductor in a flat flame-retardant system harness according to an embodiment of the present disclosure. FIG. 8A illustrates a conductor 120 from which a plurality of coupling holes A10 are removed, and FIG. 8B illustrates a conductor 120 in a form that may be used in the process of manufacturing the system harness 100 according to an embodiment of the present disclosure described with reference to FIG. 6.

When the system harness 100 is manufactured using the conductor 120 in which the plurality of coupling holes A10 are omitted, the process of forming the plurality of coupling holes A10 in step (c) of FIG. 6 will be omitted.

The above descriptions are intended to provide exemplary configurations and actions for implementing the present disclosure. The technical idea of the present disclosure will include not only the above-described embodiments, but also implementations that may be obtained by simply changing or modifying the above embodiments. In addition, the technical idea of the present disclosure will also include implementations that may be achieved by easily changing or modifying the embodiments described above in the future.

The following reference numerals can be used with the drawings.

| | |
|---|---|
| 1000: battery module | 100: system harness |
| 200: battery cell assembly | 300: upper cover |
| 110a: lower non-combustible layer | 110b: upper non-combustible layer |
| 120: conductor | 130: bus bar assembly |
| 111: connection member | 112: connector |
| 113: temperature sensor | 10a, 10b, 10c: bus bar coupling |
| | portion |
| 20: connector recess | 20a: connector coupling portion |
| 30: sensor recess | 30a: sensor coupling portion |
| 210: stack plate | 220: battery cell |
| 230: bus bar | 121: connection contact |
| 122: connector installation position | |

1. A flat flame-retardant system harness provided on a plurality of bus bars formed in a battery cell assembly, the flat flame-retardant system harness comprising:
a conductor including a plurality of connection contacts formed to be electrically connect to the plurality of bus bars, a first position formed to be connected to a battery management system (BMS), and a wiring pattern formed to electrically connect the plurality of connection contacts to the first position;
a plurality of connecting members, wherein each connection contact is electrically connected to the bus bar by a corresponding connecting member;
a lower non-combustible layer provided in contact with a lower portion of the conductor and including a plurality of first bus bar coupling portions having first holes at positions corresponding to the plurality of connection contacts; and
an upper non-combustible layer provided in contact with an upper portion of the conductor and including a plurality of second bus bar coupling portions having second holes at positions corresponding to the plurality of connection contacts,
wherein at least one of the lower non-combustible layer and the upper non-combustible layer includes a flame-retardant material.

2. The flat flame-retardant system harness of claim 1, wherein each connecting member passes through a third hole formed at the connection contact, the first hole, the second hole, and the bus bar such that the connection contact and the bus bar closely contact each other.

3. The flat flame-retardant system harness of claim 2, wherein the connecting member is a rivet.

4. The flat flame-retardant system harness of claim 1, wherein the connecting member is a device for welding the connection contact and the bus bar.

5. The flat flame-retardant system harness of claim 1, wherein the lower non-combustible layer comprises:
a bottom layer including a silicone sheet;
a top layer including a silicone sheet; and
a middle layer including a non-combustible fiber material, the middle layer being disposed between the bottom layer and the top layer.

6. The flat flame-retardant system harness of claim 1, wherein the upper non-combustible layer comprises:
a bottom layer including a silicone sheet;
a top layer including a silicone sheet; and
a middle layer including a non-combustible fiber material, the middle layer being disposed between the bottom layer and the top layer.

7. The flat flame-retardant system harness of claim 1, wherein the conductor is made of a single conductive material.

8. The flat flame-retardant system harness of claim 1, wherein the first bus bar coupling portion has a cutout cut in a ‘c’ shape around each first hole and each second bus bar coupling portion has a cutout cut in a ‘c’ shape around each second hole.

9. The flat flame-retardant system harness of claim 8, wherein the conductor further comprises a cutout cut in a ‘c’ shape around a third hole formed in the connection contact.

10. The flat flame-retardant system harness of claim 1, wherein the conductor has a second position at which a temperature sensor is installed, and further comprises a wiring pattern formed so that the second position is electrically connected to the first position.

11. A battery module comprising the flat flame-retardant system harness of claim 1.

12. The flat flame-retardant system harness of claim 1, wherein the connecting member is a device for fusing the connection contact and the bus bar.

13. The flat flame-retardant system harness of claim 2, wherein the first bus bar coupling portion has a cutout cut in a ‘c’ shape around each first hole, the second bus bar coupling portion has a cutout cut in a ‘c’ shape around each second hole, and the conductor further comprises a cutout cut in a ‘c’ shape around each third hole.

14. The flat flame-retardant system harness of claim 1, wherein the lower non-combustible layer and the upper non-combustible layer both include a flame-retardant material.
